(19) United States
(12) Patent Application Publication
(10) Pub. No.: US 2008/0000986 A1
(43) Pub. Date: Jan. 3, 2008

(54) IC tag

(75) Inventors: Kenichi Onishi, Himeji-shi (JP); Hiroshi Takata, Kobe-shi (JP); Fumihisa Ishigaki, Sapporo-shi (JP)

Correspondence Address: NIXON PEABODY, LLP, 401 9TH STREET, NW, SUITE 900, WASHINGTON, DC, 20004-2128, US

(73) Assignees: HYOGO PAPER-BOX & CORRUGATED-BOX INDUSTRY ASSOCIATION, Kobe-shi (JP); YAKA PRINTING COMPANY CO., LTD., Himeji-shi (JP); CARTON i CO., LTD., Kobe-shi (JP); TECHNOLINKS CO., LTD., Sapporo-shi (JP)

(21) Appl. No.: 11/517,583

(22) Filed: Sep. 8, 2006

(30) Foreign Application Priority Data
Jun. 29, 2006 (JP) 2006-179279

(51) Int. Cl. G06K 19/06

(52) U.S. Cl. 235/492

(57) ABSTRACT

An IC tag 1 has an IC chip 30 for storing electronic information regarding an article and a substrate 10 formed with an antenna pattern 14 connected to the IC chip 30. The substrate 10 is made of a waterproof, dimensionally stable paper substrate.

### FIELD OF THE INVENTION

The present invention relates to an IC tag storing electronic information regarding an article. Specifically, the present invention relates to an IC tag, for example, attached to a paper or cardboard package containing commercial products therein, and used for physical distribution management for identifying a physical distribution history of the commercial products or used for commodity management for determining a state of stock, warehousing and delivery of the commercial products.

### BACKGROUND OF THE INVENTION

An IC tag conventionally used has a structure in which an IC chip is mounted on a substrate made of plastic (For example, Japanese Patent Laid-open Publications Nos. 2005-100371 and 2005-332116).

A plastic film such as PET (polyethylene terephthalate) is used for the substrate of the IC tag to form a copper pattern on the substrate, which pattern is an antenna pattern for communication. A way of forming such an antenna pattern usually includes a step of chemically etching a copper film laminated on a plastic film or a step of forming a pattern by plating metal. Further, when an IC chip is mounted on a substrate, dimensional stability of the substrate is required to stably position the IC chip on the substrate without changing dimensions of the substrate, for example, due to humidity. The above-stated plastic material is used for a substrate having such dimensional stability and a chemical proof property. However, in the chemical etching step in which the plastic material is used, there are problems that a cost for the steps of lamination of the copper film and chemical etching thereof is very high, that the copper removed by the chemical etching is junked to incur a lot of waste, and that treatment of used waste of the etching liquid is needed.

Commercial products are put into commodity circulation while they are contained in a paper-packaging member such as a paper package and a cardboard package after the commercial products are produced in a factory and until they reach final users. After the paper-packaging member to which an IC tag is applied during the commodity circulation fulfills its role, it is junked as waste falling within the paper goods category. When such a junked paper-packaging member is reused as recyclable trash falling within the paper goods category, the plastic substrate which is a portion of the IC tag becomes a foreign matter within such paper goods. That is, when an object to which the IC tag is applied is made of anything except plastic material and the object is collected as recyclable trash, the plastic substrate becomes a foreign matter within such paper goods, which causes a problem that much time is needed to collect such trash and it is expensive to collect it.

Thus, a technical problem to be solved in the present invention is to provide a eco-friendly IC tag which can be made at low cost and is adapted to be reused as recyclable waste after it has fulfilled its role.

### SUMMARY OF THE INVENTION

To solve the above-stated technical problem, an IC tag according to the present invention has the following features.

The IC tag according to the present invention comprises an IC chip storing electronic information regarding an article; and a substrate formed with an antenna pattern electrically connected to the IC chip; wherein the substrate is made of a paper substrate having a water-resistant property and dimensional stability.

In this IC tag, since the substrate is made of a paper material having a water-resistant property and dimensional stability, the antenna pattern can be precisely formed on the substrate and the IC chip can be accurately positioned thereon so that an IC tag having a desired communication property can be manufactured at a low cost. Further, since an easily reusable material, namely, paper is employed in the IC tag, after the IC tag fulfills its role, it can be reused as recyclable waste, and thus it is eco-friendly.

Regarding the paper substrate having a water-resistant property and dimensional stability, water-proof and moisture-proof paper such as waxed paper, paraffin paper and oil paper which is impregnated with wax or drying oil can be used, but, preferably, a paper substrate is coated with polymer having a principal chain of a siloxane bond. The siloxane bond formed between cellulose fibers in a paper results in the paper substance having an increased tensile strength, a good water-shedding property, a good waterproof property and appropriate flexibility.

The siloxane bond is made by using a sol-gel method. Alkoxysilane is dissolved into alcohol as a main ingredient thereof, a catalyst (hydrolyzable organic metallic compound (metallic alcoxide)) is added thereto and the alcohol is sufficiently beat and ripened to fabricate a coating liquid. By utilizing moisture existing on a surface or inside of the paper, a reaction by which a siloxane bond network is obtained in a short time occurs.

The antenna pattern is made by using a paste including conductive particles.

Regarding the conductive particles, metallic powder such as gold, silver, copper and nickel powder, carbon powder such as carbon black and graphite, and metallic oxide such as tin oxide and indium oxide can be used, and, in view of conductivity and reliability, silver is superior to other metallic powders.

Since the paper substrate according to the present invention has a water-resistant property and dimensional stability, when the IC chip is directly mounted on the paper substrate, positional shift of the IC chip hardly occurs. However, to obtain better dimensional stability, namely, to considerably reduce positional errors of the IC chip, the IC chip is preferably mounted on a paper substrate carried by a release film via an adhesive layer. By integrating the release film having a considerably high dimensional stability with the paper substrate, the dimensional stability of the paper substrate can be enhanced.

The paper substrate carried by the release film is provided in a form of a roll.

The adhesive layer may be applied to the whole area of the paper substrate, but when an area of forming the adhesive layer increases, a material cost thereof increases. In this connection, to reduce the material cost, the adhesive layer can be formed on only necessary portions of the substrate. Further, the paper substrate is required to have tensile strength so that a separation between the release film and the substrate does not occur when an IC tag is mounted on the substrate fed from a roll thereof. Thus, to reduce cost and to meet the tensile strength requirement, the adhesive layer is preferably formed in the form of stripes along a feeding or supplying direction of the substrate from the roll.

Since the IC tag according to the present invention has a main component of the paper substrate which is easily combustible and has a low pollutional property, it can be attached to various members. Preferably, the IC tag is attached to a paper-packaging member so that it is not an obstacle to recycling when the paper-packaging member is treated as recyclable waste.

The IC tag can store a lot of electronic information. The IC tag is preferably attached to a paper-packaging member, such as a paper and cardboard package, during a manufacturing process thereof to consistently manage the paper-packaging member so that a history of the packaging member and customer's goods therein can be identified, namely, the history including information of processing management and/or inventory management in the starting manufacturing process of the paper-packaging member, and information that the paper-packaging member is delivered to a customer, the customer's goods are packed into the paper-packaging member, physical distribution thereof is finished and the paper-packaging member is finally discarded. Thus, the IC tag is preferably attached to a carton blank which is located upstream of these processes.

### BRIEF DESCRIPTION OF THE DRAWINGS

In the accompanying drawings:

FIG. 1 is a cross-sectional view of an IC tag which is an embodiment of the present invention;

FIG. 2 is a plan view of the IC tag shown in FIG. 1; and

FIG. 3 is a view schematically explaining a method of manufacturing the IC tag according to the present invention.

### DETAILED DESCRIPTION OF THE PREFERRED EMBODIMENTS

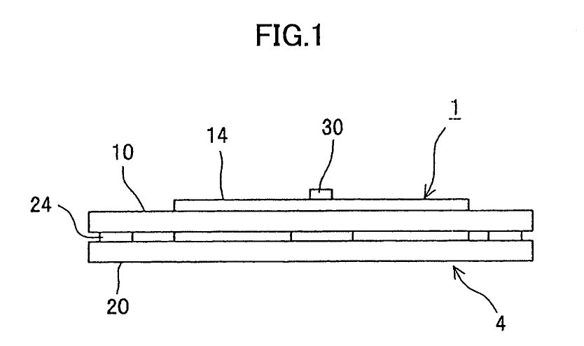

Now, referring to FIGS. 1-3, an IC tag 1 which is an embodiment of the present invention will be explained in detail. The IC tag 1 explained hereinafter is mainly applied to a paper-packaging member such as a paper package, a cardboard, a paper bag, a packaging paper, a poster and, preferably, a carton blank which has not been formed into a box. However, it goes without saying that the IC tag can be used by applying it to another member such as a resin container and a resin tray.

As shown in FIG. 1, the IC tag 1 according to the present invention has a structure in which an IC chip 30 consisting of a silicon chip is mounted on a paper substrate 10. Electronic information is stored in the IC chip 30, which information relates to a history of a paper-packaging member starting from production management and/or inventory management information during a manufacturing process thereof and including information that the packaging member is delivered to a customer, the customer's commercial goods are packed into the packaging member, the goods within the packaging member are delivered to consumers, and the packaging member is finally discarded due to end of its physical distribution. The IC chip 30 may be an IC chip with a semiconductor integrated circuit or an LSI chip having a high integration degree.

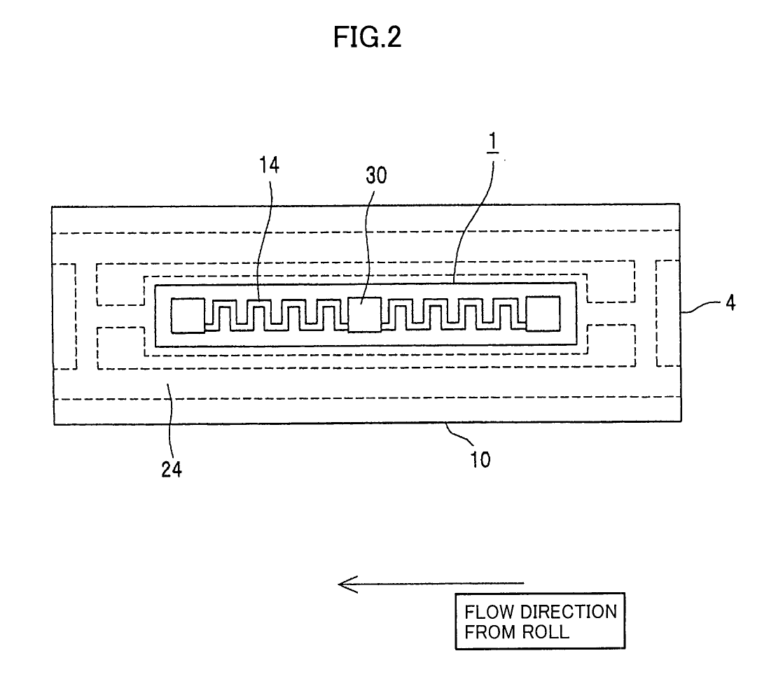

On a front surface of the paper substrate 10, an antenna pattern 14 is formed. Each of electrode terminals in a center portion of the antenna pattern 14 is electrically connected to connecting terminals of the IC chip 30. A variety of antenna patterns can be employed depending on a wavelength of a radio wave to be used therefor. For example, an antenna pattern shown in FIG. 2 can be employed. The antenna pattern 14 may be formed by a printing process or a transferring printing process.

Generally, paper is likely to be affected by moisture and humidity therearound. When a paper absorbs moisture or humidity, it is expanded so that a dimension of the paper is changed. When a standard paper is used as the substrate of the IC tag 1, due to water absorption thereof, it becomes difficult to accurately place the IC chip 30 on the substrate and to accurately make the antenna pattern 14. Thus, in the present invention, the substrate is made of a paper substrate having a water-resistant property and dimensional stability.

Regarding the paper substrate 10 having a water-resistant property and dimensional stability, waterproof and moisture-proof paper such as waxed paper, paraffin paper and oil paper which is impregnated with wax or drying oil can be employed. Preferably, the paper substrate may be coated with polymer having a principal chain of a siloxane bond. The siloxane bond formed between cellulose fibers of a paper provides a paper having an increased tensile strength, a good water-shedding property, a good water-proof property and appropriate flexibility.

In the paper substrate 10 having a water-resistant property and dimensional stability due to formation of a silicone bond, siloxane bond networks are made by activating a hydrolyzable organic metallic compound (metallic alcoxide) as a catalyst to a solution having a main medium of alkoxysilane; specifically, by penetrating the solution into paper fibers due to a capillary phenomenon and reacting it with the hydrolyzed organic metallic compound. Namely, the siloxane bond is made by using a so-called sol-gel method. Such papers suitable for water-resistant treatment include, for example, high-quality paper, glassine paper, kraft paper, non-coating white paper board (such as ivory sides and cards), gray cardboard, yellow cardboard, chip cardboard, kraft cardboard, and brown cardboard. The alkoxysilane solution is coated on a paper by using a general printing method such as a gravure printing method or a silk screen printing process or by using another process such as a roll coating process or a dipping process.

The antenna pattern 14 is formed by using a low resistance paste including a conductive filler which has conductivity almost equal to that of a conventionally-used copper film and by conducting a printing process or a transfer printing process. Such a printing process may be a gravure printing process, an offset printing process or a silk printing process. To reduce a circuit resistance of the antenna pattern 14, the silk printing process is preferable because it allows a thick membrane of the paste to be made. In view of the mass production of the antenna pattern 14, a rotary silk printer is preferable. In the transfer printing process, a way of printing the antenna pattern 14 on a release substrate and then using it as a transfer printing head can be employed. Regarding the conductive filler, metallic powder such as gold, silver, copper and nickel powder, powder of carbon such as carbon black and graphite, and powder of metallic oxide such as tin oxide and indium oxide can be employed. In the paste for the printing process, 50 weight % or more of the conductive filler is preferably contained. Preferably, the metallic powder has a crystal in a scale-like or needle-like form and is not likely to be oxidized, and thus silver is preferable to other metallic powders. Specific resistance of the antenna pattern 14 is preferably low, that is, in an order of 10⁻⁶ Ω·cm.

For a conductive ink, an oxidation-polymerization-type ink and an ultraviolet-curing-type ink can be employed. The oxidation-polymerization-type ink is an ink which contains fat including a double bond of C—C and an oxidation polymerization promoting catalyst and/or pigment and is cured by oxidation polymerization due to existence of an enzyme. For the fat including a double bond of C—C, unsaturated fatty acid can be used, while, for the oxidation polymerization promoting a catalyst, metal salt of organic carboxylic acid can be used. The ultraviolet-curing-type ink is an ink which is instantaneously dried by irradiating ultraviolet light thereto.

An oxidation-polymerization-type conductive ink is preferably a silver paste conductive ink, for example, RFZ-620 available from Toyo Ink Manufacture Co. Ltd. This conductive ink includes a solid content of 70% and has values of viscosity of 3.7 (E type viscometer; 5 rpm), TI (thixotropic index) of 3.2 and volume resistance of 1.5×10⁻⁶ Ω·cm. A low resistance pattern can be obtained by drying this conductive ink with heated wind in a dryer having a temperature inclination, namely, 200° C. in a first zone thereof and 220° C. in second, third and forth zones thereof A thickness of the pattern after this conductive ink is dried and cured is about 6-8 μm.

A high conductive silver paste available from Fujikura Kasei Co. Ltd., for example, model number XA-9053, is also appropriate. This high conductive paste has a low resistance because it is made by mixing silver oxide micro particles with a reducing agent such as ethylene glycol and heating them at a low temperature of approximately 150° C. to reduce silver oxide to silver so that silver particles contact each other. Namely, an oxide film formed on a surface of a metal is removed by utilizing reducing reaction so that the surface of the metal is exposed.

An adhesive layer 24 consisting of an adhesive component or adhesive agent is provided on the opposite surface (back surface) of the front surface of the paper substrate 10 on which the IC chip 30 is mounted, i.e., the antenna pattern 14 is formed. Further, a release film 20 is detachably applied to the adhesive layer 24 (back surface). The release film 20 is a PET (polyethylene terephthalate) film which is surface-treated so that it is easily released.

The release film 20 has not only a release function for exposing the adhesive layer 24 when needed but also a pitch-maintained function (displacement-resistant function) for ensuring a predetermined pitch or dimension of the paper substrate 10 when the IC chip 30 is mounted thereon.

Since the paper substrate 10 having a water-resistant property and dimensional stability is used as a base member, pitch or dimensional fluctuation of the paper substrate 10 is restricted. However, in order to further restrict such pitch or dimensional fluctuation of the paper substrate during mass production thereof, the paper substrate 10 is preferably carried on the release film 20 having a high-grade dimensional stability through the adhesive layer 24.

A method of forming the adhesive layer 24 can be appropriately selected from a direct printing process such as a silk printing process and a gravure printing process, and a pattern transferring process. Among them, the silk printing process is preferable. After a liquid adhesive material or agent is directly printed on the release film 20 by the silk printing process to be laminated thereon, an ultraviolet (UV) ray is irradiated from a release-film-side to cure the adhesive material or agent coated thereon in a pattern form. The UV irradiating type adhesive material is preferably UV cured type adhesive material UPSA-906 available from The Intec Co., Ltd.

The adhesive layer 24 may be formed on the whole paper substrate 10. However, since an area of the adhesive layer 24 formed on the paper substrate is large, cost of the adhesive material is high. Thus, forming the adhesive layer 24 on only necessary portions of the substrate 10 is effective for reducing the cost of the adhesive material and agent. When the IC chip 30 is mounted on the paper substrate provided in a form of a roll, tensile strength in a feeding or supplying direction from the roll should be ensured to be enough to prevent a separation between the release film 20 and the paper substrate 10. In view of the above, to reduce the cost of the material and ensure sufficient tensile strength, the adhesive layer 24 is preferably formed in a form of stripes extending along the feeding direction from the roll. Therefore, as exemplarily shown in FIG. 2, the adhesive layer 24 (a portion shown by dotted lines) is preferably formed in a form having two side stripes and one central stripe disposed side-by-side along the feeding direction from the roll.

Next, a way of making an IC tag 1 and use thereof will be explained.

A good quality paper wound in the form of a roll is extended in the form of a sheet and then a front and back surfaces thereof are coated with an alkoxysilane coating liquid (for example, SPK-9028 available from Kazari•ichi Co., Ltd.) by a roll coater or a gravure coater. After the sheet is coated with the coating liquid and dried in an environment of 150° C. for ten minutes, the sheet is wound in the form of a roll. Thus, a paper substrate 10 having a water-resistant property and dimensional stability due to the siloxane bonding is formed.

On the front surface of the paper substrate 10 coated with water-resistant and water-shedding polymer, a plurality of antenna patterns 14 are formed or printed with the above-stated silver paste conductive ink by means of a rotary screen, the antenna patterns 14 being arranged repeatedly along a longitudinal direction of the sheet. The paper substrate 10 with the printed antenna patterns 14 is dried by passing it through a drying furnace at a speed of 10-20 meters per minute, the drying furnace having a temperature gradient, namely, an inlet temperature of 200° C. and an outlet temperature of 220° C., and then the paper substrate 10 is wound in a form of a roll. A plurality of rows of the antenna patterns 14 in a width direction of the sheet can be formed. In this case, after the formation of the plurality of rows of the antenna patterns 14, the antenna patterns 14 are slit-processed along the longitudinal direction of the sheet at a predetermined width so that each row of the antenna patterns 14 is wound in the form of a small roll. Thus, a small roll of antenna patterns 14 arranged repeatedly in the longitudinal direction in one row can be formed.

On the back surface of the paper substrate 10, patterns of ultraviolet-reactive-type adhesive coating liquid are printed in the form of stripes extending in the longitudinal direction of the sheet, and then a transparent release film 20 is laminated thereon. By irradiating an ultraviolet ray toward the substrate 10 from the back surface of the paper substrate 10 laminated with the release film 20, the adhesive coating liquid obtains an adhesive property so that an adhesive layer 24 is formed between the paper substrate 10 and the release film 20.

While tension is applied to the paper substrate 10 laminated with the release film 20, the IC chips 30 are mounted on the front surface of the paper substrate 10. An adhesive is deposited or applied on the IC chip 30 except for portions of a pair of connecting terminals thereof. By curing the adhesive while the pair of connecting terminals of the IC chip 30 physically contacts a pair of electrode terminals of the antenna pattern 14, the IC chip 30 is fixed to the paper substrate 10 and electrically connected to the antenna pattern 14. Alternately, the IC chip 30 can be fixed to the paper substrate 10 and electrically connected to the antenna pattern 14 by interposing an electrical connecting member such as a conductive adhesive and a solder between the connecting terminals of the IC chip 30 and the electrode terminals of the antenna pattern 14 and curing the electrical connecting member. Then, the IC tag 1 is trimmed therearound to form a half-die-cut state in which a cut is made from the front surface of the paper substrate 10 to just before the release film 20. Thus, a base sheet 2 mounting the IC chip 30 thereon is wound in the form of a base-sheet roll 6.

The adhesive layer 24 may be formed on only necessary portions of the paper substrate 10, namely, portions where the antenna patterns 14 are formed, or on the necessary portions and unnecessary portions therearound.

In the case where the adhesive layer 24 is formed on the unnecessary portions around the antenna patterns 14, the adhesive on the unnecessary portions may be previously collected as a scrap and thus the base sheet 2 is defined so that the adhesive only on the necessary portions where the antenna patterns 14 are formed remains on the release film 20.

In the case where the adhesive layer 24 is formed on only the necessary portions in the form of stripes, as explained later, when the IC tag 1 and the unnecessary portion (scrap portions) are attached together to a paper-packaging member, only the IC tag is applied to the paper-packaging member while the unnecessary portion (scrap portion) without the adhesive layer 24 is not applied thereto and thus the latter portion can be separated and collected. In this connection, since the necessary portions of the paper substrate 10, the unnecessary portions thereof (scrap portions), and the release film 20 are separately collectable, recycling thereof is facilitated.

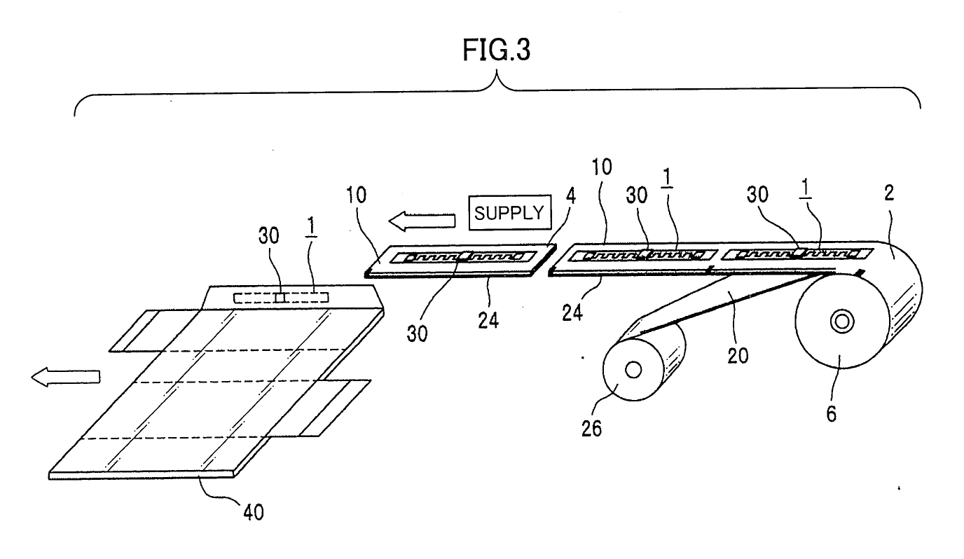

Next, referring to FIG. 3, use of the IC tag 1 will be explained.

The base sheet 2 with the IC tag 1 is used for labeling a paper-packaging member.

The base sheet 2 wound in the form of a base-sheet roll is formed with an adhesive layer 24 in the form of stripes on the necessary portions of the paper substrate 10 where the antenna patterns 14 are formed. A collecting roll 26 is disposed below the base sheet 2. The paper substrate 10 of the base sheet 2 is extended in the form of a sheet, from a right-hand side to a left-hand side in FIG. 3, while a left end of the paper substrate 10 of the base sheet 2 is tensioned. The paper substrate 10 is fed horizontally toward the left-hand side at a predetermined pitch, while a release film 20 is peeled off from the base sheet 2 by the collecting roll 26 disposed below the base sheet 2 and the peeled release film 20 is collected in the collecting roll 26.

The paper substrate 10 including the IC tag 1 is grasped at the left and right ends on the front surface thereof by grasping means (not shown) and then it is cut off by slitting the paper substrate 10 at the right end thereof. The left-hand end on the front surface of a cut-off body of the paper substrate 10 is grasped by grasping means (not shown) to stand by for the next cut-off step.

The paper substrate 10 including the IC tag 1 is applied to a predetermined location on a carton blank 40 for a paper-packaging member such as a paper package and a cardboard by a labeling machine (not shown). In the carton blank 40 to which the paper substrate 10 with the IC tag 1 is applied, the necessary portion and the unnecessary portion of the IC tag 1 are present. Since the adhesive layer 24 in the form of stripe is formed only on the necessary portions of the IC tag 1, only the IC tag is applied to the paper-packaging member while the unnecessary portion (scrap portion) without the adhesive layer 24 is separated and collected.

The carton blank 40 to which the IC tag 1 is applied is formed into a box in an assembling step at a manufacturer of paper-packaging members such as paper packages and cardboards. Electronic information with respect to process management and/or inventory management of the paper-packaging member is written into the IC chip 30 by wireless communication input/output means.

The paper-packaging member, such as a paper package or cardboard, with IC tag 1 is delivered to a customer. At the customer's place, customer's goods are packed into the paper-packaging member. At that time, electronic information with respect to a property of the customer's goods, processing management and/or inventory management is additionally written into the IC chip 30 by wireless communication input/output means. The paper-packaging member, such as a paper package or cardboard, with the IC tag 1 in which the goods are packed is transported to an end-consumer. When the goods have a problem, the wireless communication input/output means is disposed over the IC chip 30 to read the electronic information stored in the IC chip 30. Further, by tracing back the history of the goods, what the cause of the problem is can be rapidly investigated. Therefore, according to the present invention, a history from an upstream to a downstream with respect to an article, namely, a paper-packaging member and/or goods therein can be rapidly obtained.

In the above-mentioned embodiment, although the IC tag 1 is applied to the paper-packaging member, it can be applied to any other members. Further, since the IC tag according to the present invention has the paper substrate 10 as a main component, which paper substrate 10 is easily combustible and has a low pollutional property, the IC tag 1 is not an obstacle to recycling when it is treated as recyclable waste. Also since the IC chip 30 which is a component of the IC tag 1 is usually made of silicon having a relatively large specific gravity, when recyclable waste of the IC chip 30, the paper substrate 10 and the paper-packaging member are beaten to break them, the IC chip 10 is settled due to a difference of specific gravity, and thus it can be easily separated and collected. Thus, the IC chip is not an obstacle to recycling.

What is claimed is:

1. An IC tag comprising:
an IC chip storing electronic information regarding an article; and
a substrate formed with an antenna pattern electrically connected to the IC chip;
wherein the substrate is made of a paper substrate having a water-resistant property and dimensional stability.

2. The IC tag according to claim 1,
wherein the paper substrate is coated with a polymer having a principal chain of a siloxane bond.

3. The IC tag according to claim 2,
wherein the siloxane bond is made by using a sol-gel method.

4. The IC tag according to claim 1,
wherein the antenna pattern is made by using a paste including conductive particles.

5. The IC tag according to claim 4,
wherein the conductive particles consist of silver.

6. The IC tag according to claim 1,
wherein the IC chip is mounted on the paper substrate carried by a release film through an adhesive layer.

7. The IC tag according to claim 6,
wherein the paper substrate carried by the release film is delivered in the form of a roll.

8. The IC tag according to claim 7,
wherein the adhesive layer is formed in the form of stripes along a feeding direction from the roll.

9. The IC tag according to claim 1,
wherein the IC tag is attached to a paper-packaging member.

10. The IC tag according to claim 9,
wherein the paper-packaging member to which the IC tag is attached is a carton blank.

11. A paper-packaging member to which the IC tag according to claim 1 is attached.
